(19) United States
(12) Patent Application Publication
(10) Pub. No.: US 2026/0152084 A1
(43) Pub. Date: Jun. 4, 2026

(54) Ascertaining the Presence of an Intermediate Storage Device in a Local Grid

(71) Applicant: Bayerische Motoren Werke Aktiengesellschaft, Muenchen (DE)

(72) Inventors: Jens BERGER, Muenchen (DE); Mark PILKINGTON, Muenchen (DE)

(21) Appl. No.: 19/122,346

(22) PCT Filed: Sep. 1, 2023
(86) PCT No.: PCT/EP2023/073982

§ 371 Date: Apr. 18, 2025

(30) Foreign Application Priority Data
Oct. 19, 2022 (DE) 10 2022 127 446.2

(51) Int. Cl. B60L 53/62; B60L 53/30; H02J 3/32

(52) U.S. Cl. CPC B60L 53/62; B60L 53/305; H02J 3/322

(57) ABSTRACT

A method for ascertaining whether an intermediate storage device is connected to a local electric power grid of a property is provided. A first energy meter is provided at a grid connection point between the local power grid and a public power distributing grid. A charging point for an electric vehicle is connected to the local power grid via a second energy meter. When an electric vehicle is connected to the charging point, a base output is measured by the first energy meter during a charging rest phase of the electric vehicle. A battery of the electric vehicle is charged using an output measured by the second energy meter and an output is measured by the first energy meter. A determination is made whether the charging output measured during the charging process corresponds to the difference between the output measured by the first energy meter and the base output.

### BACKGROUND AND SUMMARY

The present disclosure relates to a method for detecting the presence of an intermediate storage device connected to a local electrical power supply system of a property, wherein a first energy meter is present at a grid connection point between the local power supply system and a public power distribution grid. The present disclosure also relates to a property conditioned to run the method. The present disclosure further relates to a system comprising a property and at least one electric vehicle connected to a charging point of the property. The present disclosure may be applicable to single-family houses having a power supply device, in particular a photovoltaic installation.

Bidirectional charging, i.e. charging and discharging, of an electric vehicle is known in principle. In this context, a distinction is usually drawn between “Vehicle-to-Home”, V2H, and “Vehicle-to-Grid”, V2G, applications. In the V2H application, the vehicle battery of the electric vehicle is used as an electrical intermediate storage device when the electric vehicle is connected to a home charging point (e.g. a so-called “wall box”). During the day, for example, the vehicle battery can be charged with surplus energy from a home solar or voltaic installation. At night, electrical energy from the vehicle battery is fed into the local power supply system (house power system). This increases the home's own consumption of self-generated solar power and decreases the purchase of grid power from a public power distribution grid. In the V2G application, the vehicle battery is charged when energy prices on the energy market are low, and discharged when energy prices on the energy market are high. This allows revenues to be generated by arbritage between the purchase price and the selling price. Flows of power or energy are typically planned and controlled by a home energy management system, HEMS, in combination with the at least one charging point or the at least one electric vehicle, in particular taking account of mobility demands on the electric vehicle.

Field tests have shown that the local power supply system is often configured differently than specified by its operator (e.g. a homeowner). By way of example, power generation devices, static electrical intermediate storage devices and/or electrical end loads are not specified to the HEMS or not specified with the correct device parameters. These unspecified or incorrectly specified “parasitic” energy sources and/or sinks also adversely affect the automatic control of a charging process (i.e. a charging and/or discharging process) of the electric vehicle, which can lead to an upsurge in the system comprising the electric vehicle and the intermediate storage device.

In the V2H application, for example, if, although a static intermediate storage device is connected to the local power supply system, said static intermediate storage device is not known to the HEMS or not taken into account by the HEMS, electrical energy that is supposed to be fed into the local power supply system from an electric vehicle with feedback capability can flow into the static intermediate storage device while power for end loads needs to be purchased from the public distribution grid, even though the static intermediate storage device could also be charged later. Additionally, local automatic zero-load control at the grid connection point can be disrupted by the presence of the static intermediate storage device.

In the V2G application, a static intermediate storage device that is not registered with the HEMS can cause the energy fed in by the electric vehicle not to be fed into the public power distribution grid as desired, but rather to be stored in the upstream local power supply system before.

U.S. Pat. No. 10,913,374 B2 discloses a control device for controlling a home energy management system, HEMS. The control device for controlling the HEMS contains a communication unit, which is configured to receive energy management information that includes an amount of photovoltaic power generation, an amount of power consumption by a domestic appliance, a remaining amount of power in a battery of an electric vehicle, a minimum amount of charge for the electric vehicle from a gateway of the HEMS, and a control unit, which is conditioned to control the power of the battery provided in the electric vehicle such that the electric vehicle operates in a charge mode or a discharge mode on the basis of the energy management information.

DE 10 2012 202 465 A1 discloses a power supply system comprising a solar power generation part, an electricity storage part, a consumption control part, a computation part for the predicted amount for calculating a predicted amount of consumed electricity and a predicted generated amount of electricity, a shortfall computation part for calculating a shortfall, which is a difference between the predicted consumed amount of electricity and the predicted generated amount of electricity, and a storage amount setting part for setting a predicted amount of stored electricity. In a specified time window, in which electricity costs are lower than in other time windows, the consumption control part performs the control in such a way that the electricity storage part stores electrical supply electricity delivered to a building until an amount of electricity stored in the electricity storage part reaches the predicted stored amount of electricity. If, in the other timeslots, an amount of solar power generation is greater than an amount of electricity consumed by an electrical load, the control part performs the control in such a way that the electricity storage part stores a surplus of solar electricity.

DE 11 2019 000 842 T5 discloses a charging/discharging device (1). The charging/discharging device includes a selection input in order to determine load-dependent power estimate data, which specify an estimate of a power that will be consumed by an electrical load, on the basis of load current value data that specify a load current value, in order to determine power estimate data, which are dependent on solar power generation and specify an estimate of the power that will be generated by a solar power generation system, on the basis of data relating to estimated local insolation, and in order to determine one of multiple specific modes of operation in relation to electricity use on the basis of the load-dependent power estimate data and the power estimate data that are dependent on solar power generation and on the basis of operating mode data, which specify an operating mode that designates a method of electricity use, price data, which specify a price of the AC power that is supposed to be delivered by a commercial system and a price of the AC power that is supposed to be delivered to the commercial system, power conversion efficiency data, which specify a power conversion efficiency of a power converter during charging or discharging of the storage battery, and present time data.

An object of the present disclosure is to provide a way of easily automatically detecting the presence or absence of an electrical intermediate storage device in a local power supply system of a property.

This object is achieved according to the features of the present disclosure. Preferred embodiments are also disclosed herein.

This object is achieved by a method for detecting the presence of an intermediate storage device connected to a local electrical power supply system of a property, wherein
a first energy meter is present at a grid connection point between the local power supply system and a public power distribution grid, and
a charging point for an electric vehicle is connected to the local power supply system via a second energy meter, and
wherein the method involves, when an electric vehicle is connected to the charging point,
(a) a basic power being measured by the first energy meter during a charging rest phase of the electric vehicle,
(b) a battery of the electric vehicle being charged at the charging point with a charging power measured by the second energy meter, and a power simultaneously being measured by the first energy meter,
as an alternative or in addition to step (b),
(c) the battery of the electric vehicle being discharged at the charging point with a discharging power measured by the second energy meter, and a power simultaneously being measured by the first energy meter,
(d) a check being performed to ascertain whether the charging power measured during a charging process corresponds at least approximately to the difference between the power measured by the first energy meter and the basic power, and
(e) it being assumed that an intermediate storage device is not connected to the local power supply system, otherwise it being assumed that an intermediate storage device is connected to the local power supply system.

This method has the advantage that it automatically permits reliable ascertainment of the presence of an electrical intermediate storage device without this requiring dedicated and/or complex detection devices and/or methods. Rather, here the battery of the electric vehicle is used to be able to identify an electrical intermediate storage device, specifically both in the V2G application and in the V2H application. It is possible to react thereto in order to improve a power distribution in the local power supply system and/or between the local power supply system and the public power distribution grid. In particular, an upsurge due to an unspecified or unregistered intermediate storage device can be prevented. In general terms, the method involves detecting whether the power(s) fed into the local power supply system during charging (i.e. charging or discharging) of the electric vehicle correspond to the power(s) obtained from the local power supply system or whether there is a significant difference or a “shortfall”. If there is no significant difference, this suggests that an unregistered or unknown electrical intermediate storage device is not present. This makes use of the circumstance that the charging power of the electric vehicle is generally very high compared to other power sources and power sinks connected to the local power supply system, and therefore the presence or absence of an electrical intermediate storage device can be detected particularly reliably.

An energy meter measures current and voltage at a point in an electrical line, from which it is possible to calculate the power and amounts of energy at the measurement times (e.g. meter readings).

Energy is understood to be electrical energy, even if this is not explicitly specified. This applies to power and storage analogously. In the text that follows, the power measured at the second energy meter is referred to as “charging power” if a distinction is not drawn between charging and discharging, otherwise it is referred to as “charging power” or “discharging power”. The power can comprise a time characteristic of the power, e.g. in the form of a so-called load profile.

Generally, when an aspect of the present disclosure is described on the basis of a power or powers here, this aspect of the present disclosure can be described analogously on the basis of the applicable energy over a time interval that is being considered. If for example an aspect of the present disclosure is described on the basis of a power L averaged over a period of time Δt, it can also be described on the basis of the energy E=L·Δt that occurs over this period of time Δt, etc.

A property may in particular be a house, in particular a single-family house, but also a multi-family house, a small enterprise, etc.

The electrical intermediate storage device (also referred to simply as the “intermediate storage device” below) is a power or energy store connected to the property that is used to temporarily store surplus energy and discharge it when energy is required. The intermediate storage device may be an energy store that is permanently or statically connected to the local power supply system, and can also be referred to as a “static intermediate storage device”.

The first energy meter is conditioned to provide data about the electrical power flowing via the grid connection point, e.g. a load characteristic. The first energy meter may be a so-called “smart meter” provided by an external operator (e.g. measurement site operator, distribution grid operator, etc.), the external operator then needing to be ready to share these power data with the operator of the local power supply system or an instance commissioned thereby. In particular if the external operator provides only a conventional readable electricity meter or the external operator does not share the power data, the first energy meter may be an energy meter installed by the operator of the local power supply system itself that e.g. is connected topologically in series with the electricity meter of the external operator.

The electric vehicle may be a plug-in hybrid vehicle, PHEV, or a fully electrically or battery-electrically operated vehicle, BEV. By way of example, the electric vehicle may be an automobile, a motorcycle, a truck, etc. The battery is in particular a drive battery of the electric vehicle.

A charging point, also referred to as an EVSE, is used to charge the electric vehicle. The charging point may be a charging station that can be connected to the electric vehicle by way of a charging cable, in particular a wall box for a house connection. A charging point may also be a parking space that couples to the electric vehicle inductively, however.

The charging point may be a charging point that charges the electric vehicle unidirectionally, or may alternatively be a bidirectional charging point conditioned to charge an electric vehicle bidirectionally, that is to say to either charge or discharge an electric vehicle.

One development is that the charging point is conditioned to charge the electric vehicle with direct current. One development is that the charging point is conditioned to charge the electric vehicle with alternating current.

One development is that the charging point and the electric vehicle can communicate digitally via a communication channel, e.g. when a charging cable according to ISO 15118-2 and/or ISO 15118-20 is used. An electric vehicle being connected to the charging point can therefore include—depending on the type of charging point—that it is connected to the charging point by way of a charging cable or inductively.

The second energy meter can be used to record the power flowing between the electric vehicle and the local power supply system, in particular the charging power consumed for charging the electric vehicle and the discharging power fed back into the local power supply system during discharging.

A charging rest phase is understood to be a period of time in which a charging process, that is to say either a charging process or a discharging process, is not carried out. During a period of time in which the electric vehicle is connected to the charging point, charging, discharging and/or charging rest phases may alternate—e.g. depending on charging requirements and/or a charging schedule.

The basic power corresponds to a power, measured by the first energy meter, at which the electric vehicle is neither charging nor discharging. If the basic power is measured for a specific period of time, it can correspond e.g. to the highest value measured during this period, to the lowest value measured during this period or to a value that is averaged over this period.

Alternative or additional steps (a) and (b) may also be worded such that a battery of the electric vehicle is charged (i.e. charged or discharged) at the charging point with at least one charging power (i.e. a charging power and/or a discharging power) measured by the second energy meter, and a power is simultaneously measured by the first energy meter.

Step (d) can also be worded such that a check is performed to ascertain whether the difference between, on the one hand, the power measured by the first energy meter minus the basic power and, on the other hand, the charging power is at least approximately zero, or can be worded such that a check is performed to ascertain whether the difference between the power measured by the first energy meter and the basic power corresponds at least approximately to the charging power.

Step (d) comprising a check being performed to ascertain whether the charging power measured during a charging process corresponds “at least approximately” to the difference between the power measured by the first energy meter and the basic power encompasses, in particular, the two terms differing from one another by no more than a predefined variance. This variance may be e.g. a percentage value. Taking account of the variance yields the advantage that variations in the consumption of end loads connected to the local power supply system (e.g. electrical appliances) that cannot be predicted during a charging phase do not lead to an incorrect result.

If the check is positive, it can be assumed in one development that an intermediate storage device is not connected to the local power supply system, otherwise it can be assumed in one development that an intermediate storage device is connected to the local power supply system.

One refinement is that both of steps (b), relating to the charging process, and (c), relating to the discharging process, are carried out, wherein in step (d)
a substep (d1) comprises a check being performed to ascertain whether the charging power measured during the charging process corresponds at least approximately to the difference between the power measured by the first energy meter and the basic power, and
a substep (d2) comprises a check being performed to ascertain whether the discharging power measured during the discharging process corresponds at least approximately to the difference between the power measured by the first energy meter and the basic power,
and wherein
   if true for both of substeps (d1) and (2), it is assumed in step (e) that an intermediate storage device is not connected to the local power supply system.

This attains the advantage that identification of an intermediate storage device is particularly reliable. This is because if—as is also possible in principle—only one of steps (b) and (c) is carried out, then although it is rather improbable in practice, it cannot be ruled out that the intermediate storage device is fully discharged in step (b) or the intermediate storage device is fully charged in step (c), and the presence or absence of the intermediate storage device would not be detected correctly. These exceptions can be ruled out by this refinement. The refinement may also be worded such that, even if so for only one of the two substeps (d1) and (d2), it is assumed in step (e) that an intermediate storage device is connected to the local power supply system.

One development is that it is assumed that a static intermediate storage device is connected to the local power supply system only if both the charging power measured during a charging process and the discharging power measured during a discharging process are each significantly different from the power measured at the grid connection point by the first energy meter less the basic power.

The order in which steps (b) and (c) are carried out is arbitrary in principle.

If both of steps (b) and (c) are carried out, a state of charge (SoC) of the battery before and after they are carried out may be the same, and the charging and discharging can also be regarded as a mere measurement process if relevant phases have not also been stipulated over time to attain an economic and/or ecological advantage.

One development is that step (b) and/or step (c) come at a time immediately after step (a). This attains the advantage that the reliability of the method increases because the probability of the basic load already having significantly changed when steps (b) and/or (c) are carried out e.g. based on the time of day is kept low.

One refinement is that the charging power is set to a value of at least 75% of the maximum charging power, in particular to at least 90% of the maximum charging power, in particular to at least 95% of the maximum charging power, in particular to the maximum charging power. This yields the advantage that the reliability of the method can be improved because the magnitude of the charging power is particularly high compared to the basic power and therefore the influence of the basic power on the check in step (d) or in substeps (d1) and (d2) can be kept advantageously low, in particular variations in the basic power are less relevant.

One refinement is that the period chosen for carrying out the method is a nocturnal period at the location of the local power supply system, in particular during a typical night's rest, e.g. between midnight and 4 AM. This yields the advantage that electrical end loads that are actively activated by a user, such as dishwashers, washing machines, cookers, televisions, etc., are generally not running and therefore the basic power is firstly particularly low and secondly particularly invariant. Another advantage is that the probability of the electric vehicle being intended to be moved within this period is low. Additionally, the influence of a photovoltaic installation possibly connected to the local power supply system on the method is then advantageously negligible.

One refinement is that step (a) comprises a range of variation of the basic power being ascertained and step (d) comprises a check being performed to ascertain whether the charging power measured during the discharging process corresponds to the difference between the power measured by the first energy meter and the basic power within the range of variation of the basic power. This increases the reliability of the method further, as in this way the variance is quantified instead of an e.g. merely estimated predefined variance.

One refinement is that at least one electrical power generation unit is connected to the local power supply system. This is particularly advantageous for autonomously generating at least some electrical energy locally and possibly also feeding it into the public power distribution grid at a profit. Such power generation units can comprise a photovoltaic installation and/or a wind power installation, for example.

One development is that the operator of the local power supply system does not know what (“infeed”) power generated by the at least one electrical power generation unit is fed into the local power supply system. The reason for this may be e.g. that an applicable energy meter is not present or that, although there is one present, the data cannot be transferred or at least cannot be transferred in real time. Specifically when a photovoltaic installation is present, it may be advantageous to have the method run at night or to use historical values or tabulated installation values during the day, if appropriate together with a generation forecast, which can use installation parameters and a weather forecast, for example.

One refinement is that the infeed power fed into the local power supply system by the at least one power generation unit is measured by at least one third energy meter (and the measurement data are delivered to the operator of the local power supply system). This yields the advantage that the operator of the local power supply system can eliminate the influence of the at least one power generation unit on the method and can thereby improve the reliability of the method. This may be implemented e.g. by the refinement that
step (a) comprises the basic power being measured by the first energy meter during the charging rest phase of the electric vehicle and said basic power being used to calculate a reduced basic power that corresponds to the basic power measured by the first energy meter less the fed-in infeed power measured by the at least one third energy meter, and
step (d) comprises a check being performed to ascertain whether the charging power measured during a charging process corresponds at least approximately to the difference between the power measured by the first energy meter and the sum of the reduced basic power and the infeed power.

This yields the advantage that variations in the infeed power can be precisely recorded and taken into account. The reduced basic power can correspond in particular to the power consumed by end loads connected to the local power supply system.

The third energy meter may e.g. be integrated in the power generation unit or may be a separate component.

One refinement is that the integral with respect to time of a difference between the charging power of the electric vehicle, on the one hand, and the difference between the power measured by the first energy meter and the basic power, on the other hand, is used to calculate a minimum capacity of the static intermediate storage device. This yields the advantage that control of the local power supply system, in particular including the electric vehicle, can be carried out in an improved manner. Generally, the minimum capacity of the static intermediate storage device can be ascertained by integration with respect to time or summation of the differences or “shortfalls” between the power(s) fed into the local power supply system and the power(s) taken from the local power supply system. This can involve e.g. integrating over an entire charging process or only a portion thereof with respect to time. If a power generation device is present, the power(s) fed into the local power supply system can comprise the infeed power(s) thereof.

If both of steps (b) and (c) are carried out, the minimum capacity assumed for the intermediate storage device can be the highest value determined thereby. If the method is carried out repeatedly without a user having specified a value of the capacity of the intermediate storage device in the meantime, the minimum capacity assumed for the intermediate storage device can be the highest value determined.

One refinement is that steps (a) to (e) are repeated daily or weekly when the electric vehicle is connected. This allows comparatively fast automatic reaction to a connected but unregistered, or to an unconnected, intermediate storage device.

One refinement is that the property has at least one charging point for charging an electric vehicle and is equipped with or coupled to a data processing device conditioned to set up a charging schedule for charging an electric vehicle connected to a charging point. The data processing device may be a part of the property or may be an external instance such as a network server or a cloud computer. One development is that the data processing device is used as an HEMS or HEMS computer.

One refinement is that at least one first action is initiated if the data processing device is configured such that it assumes that an electrical intermediate storage device is not connected to the local power supply system and it is assumed in step (e) that an intermediate storage device is connected to the local power supply system, and/or at least one second action is initiated if the data processing device is configured such that it assumes that an electrical intermediate storage device is connected to the local power supply system and it is assumed in step (e) that an intermediate storage device is not connected to the local power supply system.

One refinement is that the first action comprises at least notifying a user and/or reconfiguring the data processing device such that it assumes that an intermediate storage device is connected to the local power supply system. The reconfiguration can also be expressed such that the intermediate storage device logs on or is registered on the data processing device. The notifying can comprise for example transmitting a message to a user terminal, e.g. of the operator of the property.

One refinement is that the reconfiguration of the data processing device comprises informing the data processing device of the minimum capacity of the intermediate storage device.

One refinement is that the second action comprises at least notifying a user and/or reconfiguring the data processing device such that it assumes that an electrical intermediate storage device is not connected to the local power supply system. Here, the reconfiguration can be expressed such that the intermediate storage device logs off or is unregistered from the data processing device.

The object is also achieved by a property, in particular a single-family house, wherein the property is conditioned to run the method as described above. The property can be designed analogously to the method, and vice versa, and has the same advantages.

As such, the property has a local power supply system to which electrical end loads such as kitchen appliances, consumer electronics, washing machines, hot water boilers, air-conditioning systems, etc. are typically connected.

The local power supply system of the property is connected to a public power distribution grid via a grid connection point, a flow of energy via the grid connection point being able to be measured by a first energy meter.

The property also has at least one charging point that can be conductively or inductively coupled to an electric vehicle, e.g. at least one wall box. A flow of energy to and from the electric vehicle can be measured by a second energy meter.

The local power supply system of the property can moreover have at least one electrical power generation unit, e.g. a photovoltaic installation. In one development, infeed power fed into the local power supply system by the at least one power generation unit can be measured by at least one third energy meter.

The local power supply system of the property can have at least one electrical intermediate storage device.

The local power supply system can be controlled by a data processing device, which may be part of the property or may be an instance external to the property, e.g. a network server or a cloud computer. The data processing device may in particular be conditioned to set up a charging schedule for charging an electric vehicle connected to a charging point. In particular for single houses, in particular single-family houses, the data processing device may correspond to an HEMS.

The object is also achieved by a system comprising a property as described above and at least one electric vehicle connected to a charging point of the property. The system can be designed analogously to the method and/or the property, and vice versa, and has the same advantages.

The properties, features, and advantages of the present disclosure that have been described above and the way in which they are achieved will become clearer and more distinctly comprehensible in conjunction with the schematic description of an exemplary embodiment that follows, which is explained in more detail in conjunction with the drawings.

### BRIEF DESCRIPTION OF THE DRAWINGS

FIG. 1 shows a system comprising a property with an electric vehicle connected thereto; and

FIG. 2 shows a possible sequence for a method for detecting the presence of an intermediate storage device connected to a local electrical power supply system of a property.

### DETAILED DESCRIPTION OF THE DRAWINGS

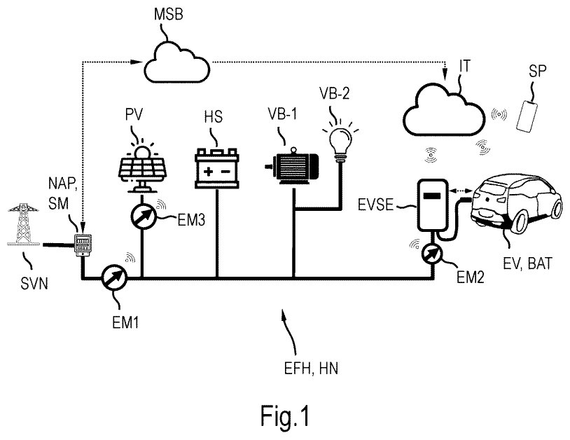

FIG. 1 shows a system EFH, EV comprising a property in the form of a single-family house EFH, the local power supply system (“home power system”, HN) of which is shown here, and an electric vehicle EV. The home power system HN is connected to a public power distribution grid EVN via a grid connection point NAP. At the grid connection point NAP there is an electricity meter SM. If the electricity meter SM is a “smart meter”, it can measure the electrical powers flowing via the grid connection point NAP and transfer them to a measurement site operator MSB, which can in turn transfer these data to a data processing device IT. Alternatively, the smart meter SM can be read locally via a digital interface. The time characteristic of the power data can e.g. be stored in the form of a load profile. If the electricity meter SM is not in the form of a smart meter or the measurement site operator MSB does not transfer the data to the data processing device IT, the operator of the home power system HN may have installed a separate first energy meter EM1 that measures the same power as the electricity meter SM and can transfer these data to the data processing device IT.

By way of illustration, the home power system HN here has multiple end loads VB-1, VB-2, optionally a power generation unit in the form of a photovoltaic installation PV, a charging point in the form of a wall box EVSE, and possibly a static intermediate storage device (“home storage device” HS) connected to it.

The wall box EVSE is connected via a second energy meter EM2 to the home power system HN, which can communicate with the data processing device IT. In one development, the second energy meter EM2 may be integrated in the wall box EVSE. One development is that the wall box EVSE can communicate with the data processing device IT directly.

The photovoltaic installation PV may be connected via a third energy meter EM3 to the home power system HN, which can communicate with the data processing device IT. In one development, the third energy meter EM3 may be integrated in the photovoltaic installation PV. An electric vehicle EV can be connected to the wall box EVSE by way of a charging cable, and can then communicate with the wall box EVSE digitally, e.g. according to ISO 15118-20. One development is that the electric vehicle EV can communicate with the data processing device IT directly.

In one development, the data processing device IT can communicate with a user terminal, in particular a mobile user terminal such as a smartphone SP, etc.

The data processing device IT may be conditioned to set up a charging schedule for charging a drive battery BAT of the electric vehicle EV, and to this end can utilize, by way of example, tariff information and/or ecological information (e.g. relating to CO₂ emissions for producing one kWh of power) from a power supplier, forecast data for the photovoltaic installation PV, e.g. a weather forecast, installation parameters, etc. The charging schedule can be negotiated in a manner that is known in principle with the wall box EVSE or with the electric vehicle EV, which set specific charging constraints, for example with regard to mobility demands on the electric vehicle EV (e.g. departure time, minimum SoC at the departure time, maximum charging power, etc.). As part of the charging schedule, the data processing device IT can moreover utilize the drive battery BAT of the electric vehicle EV as a (mobile) intermediate storage device while observing the charging constraints.

The data processing device IT is furthermore conditioned to control charging (i.e. charging and discharging) of the home storage device HS, if present, which, in a manner that is known in principle, can permit improved utilization of the electrical power of the home power system HN if the data processing device IT knows that the home storage device HS is connected to the home power system HN and/or knows that a home storage device HS that may have been present previously is no longer connected to the home power system HN.

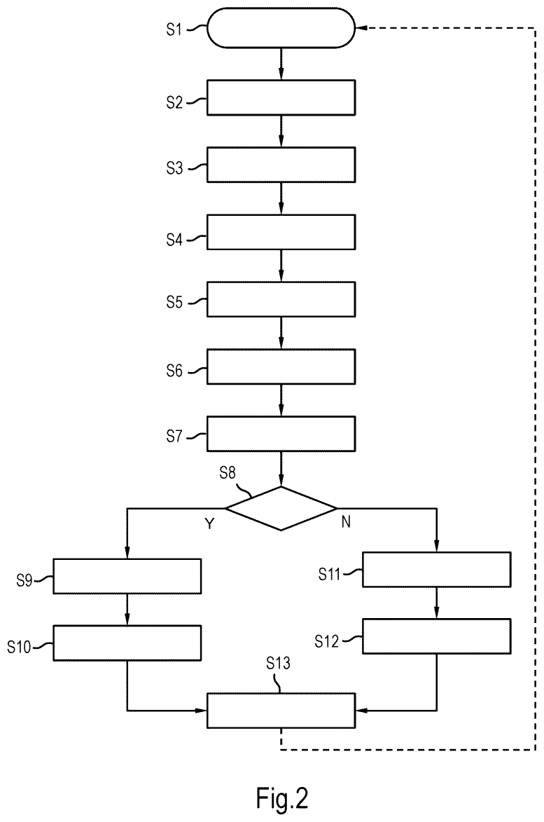

FIG. 2 shows a possible sequence for the method for detecting the presence of absence of a home storage device HS connected to the home power system HN. It is assumed that the wall box EVSE has an electric vehicle EV connected to it. It is furthermore assumed that both of steps (b) and (c) are carried out in the course of the method, i.e. a charging process and a discharging process.

In a step S1, a time to carry out the method is sought, for example during a night's rest. Additionally, a charging power is selected, preferably at least 75% of the maximum charging power. The charging power and the discharging power may differ, but do not need to.

In a step S2, a basic load or basic power L_{EM1,G}, in particular an averaged basic power L_{EM1,G}, is measured for a predefined period of time by the first energy meter EV1 during a charging rest phase of the electric vehicle EV according to step (a).

In an optional step S3, the load profile of the basic power L_{EM1,G} can be used to ascertain a range of variation ΔL_{G} with e.g. L_{EM1,G} within a band [LG−ΔL_{G}/2; LG−ΔL_{G}/2].

In step S4, merely by way of illustration, step (b) is first carried out for a specific period of time, said step involving the drive battery BAT of the electric vehicle EV being charged with a charging power L_{EM2,A} measured by the second energy meter EM2, and the power L_{EM1,A} simultaneously being measured by the first energy meter EM1.

In a step S5, a check is performed to ascertain whether the charging power L_{EM2,A} measured during the charging process corresponds at least approximately to the difference between the power L_{EM1,A} measured by the first energy meter EM1 and the basic power L_{EM1,G} (which is assumed here to be averaged by way of illustration). This can also be expressed such that a check is performed to ascertain whether

$${L}_{EM 2 , A} \approx {L}_{EM 1 , A} - {L}_{EM 1 , G} , \qquad ( 1 )$$

e.g. within a predefined range of variation 0.99. (L_{EM1,A}−L_{EM1,G})≤L_{EM2,A}≤1.01. (L_{EM1,A}−L_{EM1,G}), the predefined range of variation being arbitrarily selectable in principle. If the range of variation ΔL_{G} is ascertained by step S3, a check can be performed e.g. to ascertain whether

$$( {L}_{EM 1 , A} - {L}_{EM 1 , G} - Δ {L}_{G} / 2 ) \leq {L}_{EM 2 , A} \leq ( {L}_{EM 1 , A} - {L}_{EM 1 , G} + Δ {L}_{G} / 2 ) \qquad ( 2 )$$

holds true. If condition (1) or (2) holds true, one of the following may apply: (i) there is no home storage device HS connected to the home power system HN or (ii) the home storage device HS is empty.

If, however, conditions (1) and (2) do not hold true, but—depending on the condition used—instead L_{EM2,A}>L_{EM1,A}−L_{EM1,G}, L_{EM2,A}>1.01. (L_{EM1,A}−L_{EM1,G}) or L_{EM2,A}>L_{EM1,A}−L_{EM1,G}+ΔL_{G}/2, additional electrical power must have been provided by a power source of the home power system HN to charge the electric vehicle EV.

Assuming that the home storage device HN was not fully discharged and that the photovoltaic installation PV (if present) does not feed significantly more solar power into the home power system HN from step S2 to step S4, there is already a high probability of being able to assume that if conditions (1) and (2) hold, a home storage device HS is not connected to the home power system HS, or, conversely, a home storage device HS is connected to the home power system HS if conditions (1) and (2) do not hold.

In step S6, step (c) is carried out for a specific period of time, which involves the drive battery of the electric vehicle EV being discharged into the home power system HS with a discharging power L_{EM2,E} measured by the second energy meter EM2, and the power L_{EM1,E} simultaneously being measured by the first energy meter EM1.

In step S7, a check is performed to ascertain whether the discharging power L_{EM2,E} measured during the discharging process corresponds at least approximately to the difference between the power L_{EM1,E} measured by the first energy meter EM1 less the basic power L_{EM1,G}. This can also be expressed such that a check is performed to ascertain whether

$${L}_{EM 2 , E} \approx {L}_{EM 1 , E} - {L}_{EM 1 , G} , \qquad ( 3 )$$

e.g. within a predefined range of variation 0.99·(L_{EM1,E}−L_{EM1,G})≤L_{EM1,E}≤1.01. (L_{EM1,E}−L_{EM1,G}), the predefined range of variation being arbitrarily selectable in principle. If the range of variation ΔL_{G} of the basic power L_{EM1,G} has been calculated according to step S3, a check can be performed e.g. to ascertain whether

$$( {L}_{EM 1 , E} - {L}_{EM 1 , G} - Δ {L}_{G} / 2 ) \leq {L}_{EM 2 , E} \leq ( {L}_{EM 1 , E} - {L}_{EM 1 , G} + Δ {L}_{G} / 2 ) \qquad ( 4 )$$

holds true. If condition (3) or (4) holds true, one of the following may apply: (iii) there is no home storage device HS connected to the home power system HN or (iv) the home storage device HS is fully charged. If, however, conditions (3) and (4) do not hold true, additional electrical power must have been drawn by a sink of the home power system HN. Assuming that the home storage device HN was not fully charged and that the photovoltaic installation PV (if present) does not feed significantly less solar power into the home power system HN from step S2 to step S4, there is already a high probability of being able to assume that if conditions (3) and (4) hold, a home storage device HS is not connected to the home power system HS, or, conversely, a home storage device HS is connected to the home power system HS if conditions (3) and (4) do not hold.

In a step S8, a check is performed to ascertain whether both of conditions (1) and (2), on the one hand, and (3) and (4), on the other hand, apply. If so (“Y”), it is decided that a home storage device HS is not connected to the home power system HN, and the method branches to step S9.

In step S9, the data processing device IT is informed that a home storage device HS connected to the home power system HS has not been found.

In step 10, the data processing device IT can then configure itself such that it assumes that a home storage device HS is not connected if this was not already so beforehand. The configuration can comprise e.g. erasing a flag. Alternatively or additionally, the data processing device IT can notify a user, for example by outputting a message on their smartphone SP.

If, however, the result of the check in step S8 is that both of conditions (1) and (2), on the one hand, and (3) and (4), on the other hand, do not apply together and in particular that neither of the two conditions (1) and (2), on the one hand, and (3) and (4), on the other hand, applies (“N”), it is decided that a home storage device HS is connected to the home power system HN, and the method branches to step S11.

In step S11, the data processing device IT is informed that a home storage device HS is connected to the home power system HS.

In step S12, the data processing device IT can then configure itself such that it assumes that a home storage device HS is connected if this was not already so beforehand. The configuration can comprise e.g. setting a flag. Alternatively or additionally, the data processing device IT can notify a user, for example by outputting a message on their smartphone SP.

In a step S13 that follows step S10 and step S12, the method is terminated and, if appropriate, repeated at a later time, e.g. one day or one week later, as indicated by the dashed arrow.

The method described can also be used when the photovoltaic installation PV is present but its infeed power L_{S} is not known or not transmitted to the data processing device IT. To keep down the influence of variations in the infeed power L_{S} while the method is being carried out, the method can be carried out e.g. at night.

If the infeed power L_{S} can be measured by the third energy meter EM3 and the measurement data are transmitted to the data processing device IT, the influence of the infeed power L_{S} can be taken into account particularly precisely. By way of example, instead of the basic power L_{EM1,G} of the end loads that is determined once before charging and discharging, it is then possible to use a “reduced”, up-to-date basic power L_{G,red}, for which the time-variant infeed power L_{S} is separated from the basic power L_{EM1,G}, e.g. by virtue of L_{G,red}=L_{EM1,G}−L_{S} being set and being calculated in step S2 and possibly S3. It is then possible to use the term L_{G,red}+L_{S} instead of L_{EM1,G} in relations (1) to (4) above, for example, L_{S} being ascertained in an up-to-date manner.

The above calculations may be arithmetic-sign-sensitive, i.e. e.g. a consumption in the home power system HN has a positive arithmetic sign and the infeed power L_{S} has a negative arithmetic sign. Alternatively, all powers may be specified as absolute values, certain arithmetic signs may be adjusted in the above equations.

One development is also that the integral with respect to time of the difference between the charging power of the electric vehicle EV, on the one hand, and the difference between the power measured at the grid connection point NAP by the first energy meter EM1 and the basic power, on the other hand, is used to calculate a minimum capacity of the home storage device HS. This can be carried out for a charging process and a discharging process of the electric vehicle. If a power generation device is present, the infeed power L_{S} thereof can also be taken into account. In principle, the minimum capacity of the home storage device HS can be ascertained by integration with respect to time or summation of the “shortfalls” between the power(s) fed into the home power system HN and the power(s) taken from the home power system HN. This can involve e.g. integrating over an entire charging process or only a portion thereof with respect to time.

The data processing device IT can also be informed of this minimum capacity of the home storage device HS in step S11.

The descriptions of the various aspects and embodiments have been presented for purposes of illustration but are not intended to be exhaustive or limited to the embodiments disclosed.

As such, in the exemplary embodiment—and also generally—in addition or as an alternative to a power considered over a period, the corresponding energy can be considered. It is thus possible, e.g. in step S2, to consider an averaged energy E=L·Δt instead of the power averaged over a period Δt. Furthermore, in step S5, a check can be performed to ascertain whether the energy used for charging, measured during the charging process, corresponds at least approximately to the difference between the energy measured by the first energy meter EM1 and the averaged energy of the basic consumption.

Generally, “a”, “an”, etc., can be understood to be a singularity or a plurality, in particular in the sense of “at least one” or “one or more”, etc., unless this is explicitly ruled out, e.g. by the expression “precisely one”, etc.

Numerical information can also encompass precisely the indicated number and a usual tolerance range, unless this is explicitly ruled out.

### LIST OF REFERENCE SIGNS

BAT drive battery
EFH single-family house
EM1 energy meter
EM2 energy meter
EM3 energy meter
EV electric vehicle
EVSE wall box
HN home power system
HS home storage device
IT data processing system
MSB measurement site operator
NAP grid connection point
PV photovoltaic installation
SVN power distribution grid
SM electricity meter
SP smartphone
S1-S13 method steps
VB-1 end load
VB-2 end load

1-15. (canceled)

16. A method for detecting a presence of an intermediate storage device connected to a local electrical power supply system of a property, comprising, based on an electric vehicle being connected to a charging point:
measuring a basic power by a first energy meter during a charging rest phase of an electric vehicle;
simultaneously:
charging or discharging a battery of the electric vehicle at a charging point with a charging power or discharging power measured by a second energy meter, and
measuring a power by the first energy meter;
determining whether the charging power measured during a charging process corresponds at least approximately to a difference between the power measured by the first energy meter and the basic power, and
determining whether or not an intermediate storage device is connected to the local power supply system based on the determination whether the charging power measured during the charging process corresponds at least approximately to the difference between the power measured by the first energy meter and the basic power,
wherein:
the first energy meter is present at a grid connection point between the local power supply system and a public power distribution grid, and
the charging point for the electric vehicle is connected to the local power supply system via the second energy meter.

17. The method according to claim 16, further comprising, based on the battery of the electric vehicle having been both charged and discharged:
determining that an intermediate storage device is not connected to the local power supply system based on:
determining whether the charging power measured during the charging process corresponds at least approximately to the difference between the power measured by the first energy meter and the basic power, and
determining whether the discharging power measured during a discharging process corresponds at least approximately to the difference between the power measured by the first energy meter and the basic power.

18. The method according to claim 16, wherein:
measuring the basic power by the first energy meter during the charging rest phase of the electric vehicle comprises determining a range of variation of the basic power; and
determining whether the charging power measured during the charging process corresponds at least approximately to the difference between the power measured by the first energy meter and the basic power comprises:
determining whether the charging power measured during a discharging process corresponds to the difference between the power measured by the first energy meter and the basic power within the range of variation of the basic power.

19. The method according to claim 16, wherein the charging power is set to a value of at least 75% of a maximum charging power.

20. The method according to claim 16, wherein a period chosen for carrying out the method is a nocturnal period at a location of the local power supply system.

21. The method according to claim 16, wherein at least one electrical power generation unit is connected to the local power supply system.

22. The method according to claim 21, wherein:
infeed power fed into the local power supply system by the at least one power generation unit is measured by at least one third energy meter;
measuring the basic power by the first energy meter during the charging rest phase of the electric vehicle comprises:
measuring the basic power by the first energy meter during the charging rest phase of the electric vehicle, the basic power being used to calculate a reduced basic power that corresponds to the basic power measured by the first energy meter less the infeed power measured by the at least one third energy meter; and
determining whether the charging power measured during the charging process corresponds at least approximately to the difference between the power measured by the first energy meter and the basic power comprises:
determining whether the charging power measured during the charging process corresponds at least approximately to the difference between the power measured by the first energy meter and a sum of the reduced basic power and the infeed power.

23. The method according to claim 16, further comprising calculating a minimum capacity of a static intermediate storage device based on an integral with respect to time of a difference between the charging power of the electric vehicle and the difference between the power measured by the first energy meter and the basic power.

24. The method of claim 16, further comprising repeating the method daily or weekly when the electric vehicle is connected.

25. The method according to claim 16, wherein the property has at least one charging point for charging an electric vehicle and is equipped with or coupled to a data processing device conditioned to set up a charging schedule for charging an electric vehicle connected to a charging point, wherein the method further comprises:
initiating at least one first action based on determining that the intermediate storage device is connected to the local power supply system and the data processing device being configured to assume that the intermediate storage device is not connected to the local power supply system; and/or
initiating at least one second action based on determining that the intermediate storage device is not connected to the local power supply system and the data processing device being configured to assume that the intermediate storage device is connected to the local power supply system.

26. The method according to claim 25, wherein the first action comprises:
notifying a user, or
reconfiguring the data processing device such that it assumes that the intermediate storage device is connected to the local power supply system.

27. The method according to claim 26, wherein reconfiguring the data processing device comprises informing the data processing device of a minimum capacity of the intermediate storage device.

28. The method according claim 25, wherein the second action comprises:
notifying a user, or
reconfiguring the data processing device such that it assumes that the storage device is not connected to the local power supply system.

29. A system for detecting a presence of an intermediate storage device connected to a local electrical power supply system of a property, comprising:
a property including a charging point configured to charge an electric vehicle;
a first energy meter;
a second energy meter; and
a data processing device configured to:
measure a basic power by the first energy meter during a charging rest phase of the electric vehicle;
simultaneously:
charge or discharge a battery of the electric vehicle at the charging point with a charging power or discharging power measured by the second energy meter, and
measure a power by the first energy meter;
determine whether the charging power measured during a charging process corresponds at least approximately to a difference between the power measured by the first energy meter and the basic power, and
determine whether or not an intermediate storage device is connected to the local power supply system based on the determination whether the charging power measured during the charging process corresponds at least approximately to the difference between the power measured by the first energy meter and the basic power,
wherein:
the first energy meter is present at a grid connection point between the local power supply system and a public power distribution grid, and
the charging point for the electric vehicle is connected to the local power supply system via the second energy meter.

30. The system of claim 29, wherein the property comprises a single-family house.

31. The system of claim 29, further comprising at least one electric vehicle connected to a charging point of the property.
